(19) United States
(12) Patent Application Publication
(10) Pub. No.: US 2014/0039982 A1
(43) Pub. Date: Feb. 6, 2014

(54) Method, License Model And System For Managing Software Licenses Amongst A Group Of Devices

(71) Applicant: Siemens Aktiengesellschaft, Munchen (DE)

(72) Inventors: Claus Oberhagemann, Puchheim (DE); Kjell Oppermann, Pfaffenhofen (DE); Juergen Steuer, Muenchen (DE)

(73) Assignee: Siemens Aktiengesellschaft, Munchen (DE)

(21) Appl. No.: 13/956,644

(22) Filed: Aug. 1, 2013

Related U.S. Application Data
(60) Provisional application No. 61/678,406, filed on Aug. 1, 2012.

(51) Int. Cl. G06Q 50/18; G06Q 10/06

(52) U.S. Cl. CPC G06Q 50/184; G06Q 10/06
USPC 705/7.35

(57) ABSTRACT

An approach is provided for using a license model granting at least one license of using a software product designated for a local installation and execution on at least one device within a group of devices. The license is charged according to the actual execution time of the software on the at least one device of the group. Metrics data related to the software execution within the group are collected and a balance report for a licensor of the license is generated based on the metrics data.

### CROSS-REFERENCE TO RELATED APPLICATIONS

This application claims the benefit of U.S. Provisional Patent Application No. 61/678,406 filed Aug. 1, 2012, the contents of which is incorporated herein by reference in its entirety.

### TECHNICAL FIELD

The present disclosure relates to managing licensed software products among a group of devices. More particularly, the present disclosure relates to a method of granting a license of using a software product designated for a local installation and execution on a device.

### BACKGROUND

Traditional models for acquisition, use, and payment of software require a customer to pay for an expected number, or instances, of a software product that is intended to operate on the customer's computer network or system. For example, an organization or a company desiring to provide a software product for use by the company's employees will generally pay for one copy of the software product for each of the company's employees that will use the software product.

Such payment may give the company a license to use the software product at each of the employee work stations. The license typically prohibits copying and further distribution of the software product to other employees of the company. The company, moreover, pays a full price for each license thus obtained.

However, some or all of the company's employees may use the software product only on a part-time basis. Thus, the company in effect pays for excess capacity to ensure all of the company's desired employees have access to the software product. As an alternative, the company could acquire a limited number of software product licenses. In this alternate arrangement, some company employees may not be able to use the software product when needed or desired, thereby reducing the work output of the company.

Finally, the company's hardware needs may change rapidly. Acquisition or disposal of hardware may affect the number of software licenses the company needs to have in place. By having to separately purchase additional licenses of the software product, the company may experience delays before the newly acquired hardware is fully functional.

### SUMMARY

One embodiment provides a method for managing software licenses among a group of devices, comprising establishing a license model, the license model granting at least one license of using a software product designated for a local installation and execution on at least one device within the group, the license being charged according to an actual execution time of the software on the at least one device of the group; collecting metrics data related to the software execution within the group; and generating a balance report for a licensor of the license based on the metrics data.

Another embodiment provides a software asset management system for managing software licenses among a group of devices, comprising an interface for commercial information storing a license model, the license model granting at least one license of using a software product designated for a local installation and execution on at least one device within the group; an interface for monitoring an actual execution time of the software on the at least one device of the group and for charging the license; an interface for collecting metrics data related to the software execution within the group; and an interface for generating a balance report for a licensor of the license based on the metrics data.

Another embodiment provides a license model granting at least one license of using a software product designated for a local installation and execution on at least one device within a group, the license being charged according to the actual execution time of the software on the at least one device of the group.

Another embodiment provides a computer program product, which contains a program code stored on a computer-readable medium and which, when executed on a computer, carries out the method disclosed above. Another embodiment provides a data storage carrier that stores a computer program to cause a computer to perform a method according to claim 1.

### BRIEF DESCRIPTION OF THE DRAWINGS

Example embodiments are discussed below with reference to the drawings, which:

FIG. 1 shows a block diagram of a software asset management system in which the proposed method described herein can be implemented; and

FIG. 2 shows a license management in an organization or a company according to the proposed method described herein.

### DETAILED DESCRIPTION

An approach is provided using a license model which is granting at least one license of using a software product designated for a local installation and execution on at least one device within the group. This license is charged according to the actual execution time of the software on the at least one device of the group. Metrics data related to the software execution within the group are collected and, based on the metrics data, a balance report for a licensor of the license is generated.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

Software products used in a company need to be licensed according to an end user licenses agreement of a software vendor or according to terms and conditions agreed between the company and the software vendor.

While purchased licenses for small entities are usually protected by means like a license key associated to an installation medium and copy protection means of the installation medium, such means are not suitable for a handling in large companies.

Instead, standard software may be scripted and deployed via software deployment tools. Usually, one single license key is valid for the entire company. This facilitates software deployment but leads to challenges in software asset management.

The implementation of a global unified software lifecycle process assuring that software is only installed if the appropriate license has been purchased is neither feasible nor cost efficient for standard software with thousands of installations in the company. Accordingly, large companies prefer an implementation of a software asset management, or SAM, systems. A software asset management system ensures a balance of installed and purchased licenses and, therefore, assures legal compliance for all licenses.

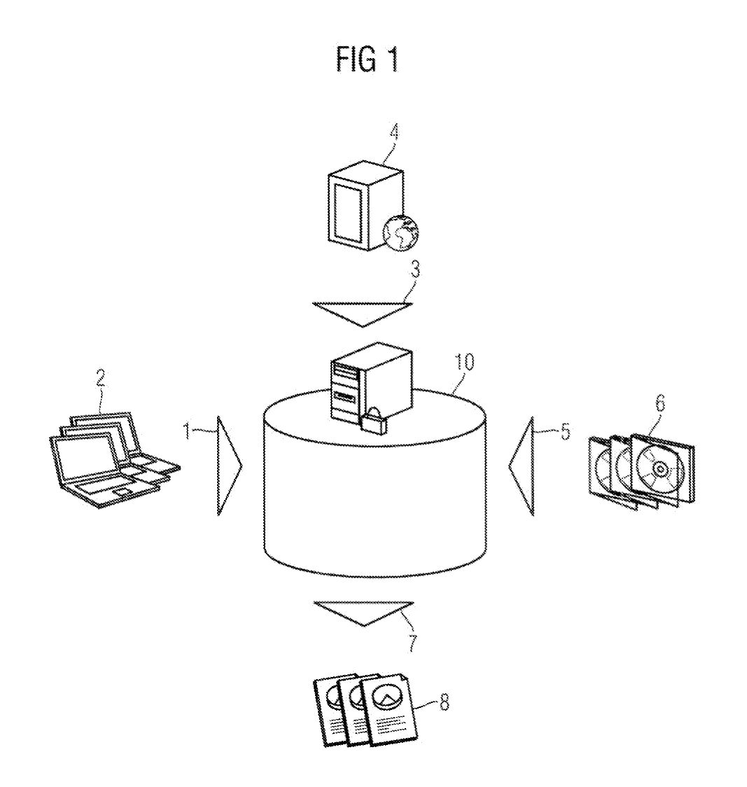

FIG. 1 is block diagram of a software asset management system 10 in view of its data sources 1,3,5,7.

A software asset management system 10 generally manages a use of software products on a multiplicity of devices, including but not limited to devices like desktop computers, laptop computers, handheld computer, mobile devices, servers etc. The software asset management system 10 manages licensed software products by ensuring contractual and legal compliance.

The data sources of the software asset management system 10 comprise an interface for exchanging inventory data 1. The inventory data include data concerning software products installed on each of a multiplicity of devices 2 and metrics data related to the execution of each individual software product on a respective device 2.

Further, an interface 3 for exchanging hardware and organizational information with at least one server 4 is provided. Hardware information is usually provided by a database containing data of all administered hardware assets. Further, architectural data, e.g. network layout etc., may be provided. Organizational information is usually provided by a database containing data of all administered users of devices.

A further interface 5 for commercial information regarding the software products 6 administered by the software asset management system 10 is provided, the commercial information including purchase orders, licenses, contracts etc.

Finally, an interface 7 for generating reports is provided. Such reports may include software metrics reports, license balance reports etc.

The software asset management system 10 further include—not shown—interfaces for monitoring, collecting, preprocessing and transmitting the metrics data.

Currently operated software asset management systems, particularly systems operated in large companies consisting of many legal entities, encounter a major problem that pooling, revoking and reusing licenses requires complex transfer processes between different legal entities of a company.

Large entities, therefore, extend agreements with software vendors in terms of global pooling of software licenses across legal entities. To this end, all licenses are purchased and centrally owned by one corporate unit and a temporary use right is granted to other legal entities as a service. Further, the agreement with software vendors considers permission of software installation while measuring the installations retroactively and subsequently purchasing missing licenses.

Such agreements allow the installation of software locally on a daily basis to fulfill a user's demand for software without checking for available licenses and without procurement of new licenses. At the same time, software is removed from devices without revoking or transferring licenses.

The license balance is evaluated by the software asset management system once a month considering a global pool and, if applicable, local pools of licenses.

A central procurement provides a centrally organized purchasing of missing licenses on a global and/or local level.

As to the cost allocation, the license share is charged by actual need. The charge per software product is determined by the software asset management system considering the consumption change per legal entity for the respective measurement period (e.g. one month). Charging information per legal entity adds up for three months before charged as a service fee to the legal entities.

Charging of service cost to legal entities will assure compliance with all commercial and tax matters.

All users of the different legal entities consume a temporary use right as long as the software is installed or used on a device. The provided time periods can alter dependent on the agreement with software vendors.

This proposed license pooling, however, has a potential drawback in that the license does not reflect the changing needs of the company. For example, a company who has already purchased a ten-user license cannot add an eleventh user instantly without having to go back to the vendor for more licenses. Neither can the company instantly reduce costs by switching to a 5-user license if customer needs so dictate.

According to an embodiment of the proposed method, installed software on devices is charged by an actual use applying a collection of metrics data.

This pay-per-use license implies a license model which grants a license of using a software product designated for a local installation and execution on at least one device within a group. The group is to be understood as a general organization of devices of any number, e.g. a company's network. The license is charged according to the actual execution time of the software on each device of the group.

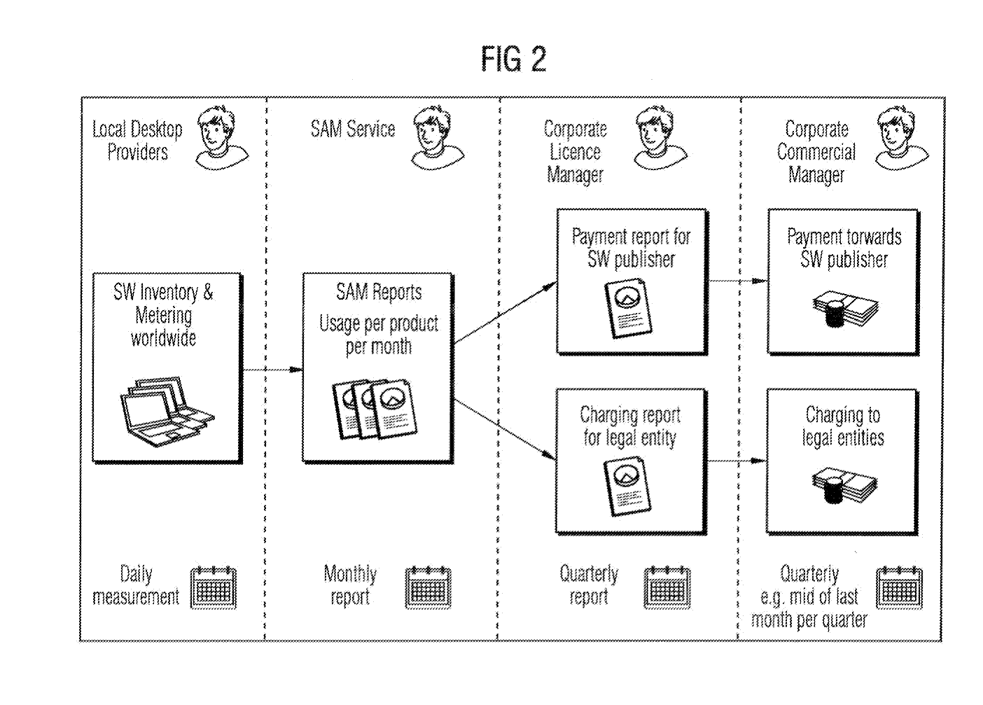

Referring to FIG. 2, representing a license management in an organization or a company according to the proposed method, metrics data related to the software execution within a group, here, a company, are measured daily whereas license costs apply only for a calculation period, e.g. a month, for which a software installation was actually used. The proposed pay-per-use license model is distinct from known >>Software as a Service<< models insofar that a software product is installed locally on a device instead of provisioning of software in a cloud.

According to an embodiment, usage related license costs are summed for three months and paid quarterly to the software vendor. In a same calculation period usage related license costs are charged to the legal entities of the company. The charging amount is based on the usage or execution of the software product assigned to the respective legal entity.

According to an embodiment, payments to software vendors considers legal and tax regulations ensuring compliance with contractual terms and conditions. Charging to legal entities considers legal and tax regulations ensuring compliance with contractual terms and conditions between the corporate unit and the legal entities.

The proposed method supports all license models such as licensing per device or licensing per named user.

A particular advantage of the proposed method is due to the fact that installation is not delayed for the need of checking license pools, purchasing licenses or assigning licenses.

Instead, software can be installed immediately on business demand. The effort of license management for each installation omits.

The license balance for each software product is efficiently reported at one place while considering all terms and conditions with the software publisher in the same way for the entire company.

The quality of the license balance is significantly higher compared to conventional software asset management systems since the same license model may be used world-wide in all legal entities, all inventory data are retrieved automatically using the standardized inventory solution and purchase orders and license evidences of procured licenses, delivered by commercial data, are centrally input into the database of the software asset management system by one person, namely, the corporate license manager.

These benefits also apply to the software vendor resulting in efficient account management and handling of order processes.

Charging to legal entities becomes more efficient since there is only one charge, or service fee, for standard software per quarter instead of one charge per order per legal entity or per cost center per product.

A particular advantage of the proposed method is that license costs only apply in a calculating period, e.g. one month, for which a software installation was actually in use.

A further advantage of the proposed method lies in the fact that users can use known powerful client software without dependency on a cloud and network connectivity.

Embodiments of the invention can be implemented in computing hardware (computing apparatus) and/or software stored on non-transitory computer-readable storage devices, including but not limited to any computer or microcomputer that can store, retrieve, process and/or output data and/or communicate with other computers.

The processes can also be distributed via, for example, downloading over a network such as the Internet. A program/software implementing the embodiments may be recorded on computer-readable media comprising computer-readable recording media. The program/software implementing the embodiments may also be transmitted over a transmission communication media such as a carrier wave.

The invention has been described in detail with particular reference to preferred embodiments thereof and examples, but it will be understood that variations and modifications can be effected within the spirit and scope of the invention covered by the claims.

What is claimed is:

1. A computer-implemented method for managing software licenses among a group of devices, the method comprising:
storing in a non-transitory storage device a license model granting at least one license for using a software product designated for a local installation and execution on at least one device within the group of devices;
using a processor to collect metrics data related to execution of the software by each device in the group;
using the processor to sum the metrics data collected from the group of devices over a predetermined time period, and determine a license balance based on the summed metrics data over the predetermined time period;
using the processor to calculate a license cost value based at least on the determined license balance; and
using the processor to report the calculated license cost value.

2. The method of claim 1, comprising:
using the processor to sum the metrics data collected from the group of devices over each of multiple instances of the predetermined time period, and determine a license balance for each instance of the predetermined time period based on the summed metrics data over that instance of the predetermined time period;
using the processor to sum the multiple license balances for the multiple instances of the predetermined time period; and
using the processor to calculate the license cost value based on the summed license balances for the multiple instances of the predetermined time period.

3. The method of claim 1, wherein metrics data related to execution of the software by each device in the group comprises data indicating installation and execution of the software on each individual device.

4. A system for managing software licenses among a group of devices, the system comprising:
a non-transitory storage device storing license rules defining a license model granting at least one license of using a software product designated for a local installation and execution on at least one device within the group of devices;
a processor communicatively coupled to the non-transitory storage device and programmed to:
access a stored license model granting at least one license for using a software product designated for a local installation and execution on at least one device within the group of devices;
collect metrics data related to execution of the software by each device in the group;
sum the metrics data collected from the group of devices over a predetermined time period, and determine a license balance based on the summed metrics data over the predetermined time period;
calculate a license cost value based at least on the determined license balance; and
report the calculated license cost value.

5. A computer program product for managing software licenses among a group of devices, the computer program product comprising a program code stored on a non-transitory computer-readable medium and executable by a processor to:
access a stored license model granting at least one license for using a software product designated for a local installation and execution on at least one device within the group of devices;
collect metrics data related to execution of the software by each device in the group;
sum the metrics data collected from the group of devices over a predetermined time period, and determine a license balance based on the summed metrics data over the predetermined time period;
calculate a license cost value based at least on the determined license balance; and
report the calculated license cost value.
